(19) United States
(12) Patent Application Publication
(10) Pub. No.: US 2013/0015706 A1
(43) Pub. Date: Jan. 17, 2013

(54) Electric outlet power control device

(71) Applicant: Chi-Ming Chien, Taipei City (TW)

(72) Inventor: Chi-Ming Chien, Taipei City (TW)

(73) Assignee: SEVENTEAM ELECTRONICS CO., LTD., Taipei City (TW)

(21) Appl. No.: 13/067,975

(22) Filed: Jul. 13, 2011

(51) Int. Cl. H02J 3/00

(52) U.S. Cl. 307/38

(57) ABSTRACT

An electric outlet power control device includes an electric outlet strip having female receptacles for providing electricity to a host computer and computer peripheral apparatuses, and a control module having a sensor for sensing the current signal of the host computer and an electric switch member controllable by the sensor to cut off power supply from all the female receptacles when the host computer is off.

### BACKGROUND OF THE INVENTION

1. Field of the Invention

The present invention relates to power control technology and more particularly, to an electric outlet power control device, which automatically cuts off power supply from all female receptacles when a host computer at one female receptacle is off.

2. Description of the Related Art

Following the progress of modern technology, the living quality has been greatly improved. Nowadays, many different electric and electronic products, such as desk computer, notebook computer, PDA, copier, fax machine, printer, TV, audio system, air conditioner, refrigerator, washing machine, electric fan, electric cooker and etc. are used in every family or office, assisting people to do many different works rapidly and safety and bringing convenience and comfort to people. Further, following development of technology, advanced electric and electronic products are continuously promoted to serve people. When using many different electric and/or electronic products in a family or office, the limited number of available wall electric outlets in the family or office may be insufficient. In this case, an extension electric outlet strip may be necessary.

Further, conventional electronic and electric devices may be specifically designed for different purposes. Many different electronic devices may be arranged into a system for application. For example, a host computer may be used with a printer, a scanner, a speaker system, a router, a splitter, a LCD monitor, and/or many other peripheral devices as a complete system for information operating, exchanging, fetching or storing operations.

An early design of electric outlet strip simply provides multiple female receptacles for the connection of electric/electronic devices. When using an early design of electric outlet strip, the user must connect the electric plug of the power cable of the electric outlet strip to a city power supply outlet and then connect the electric plug of the power cord of each electric/electronic device to the female receptacles. When not in use, the user must disconnect the electric plug of the power cable of the electric outlet strip from the city power supply outlet. It is inconvenient to frequently plug and unplug the electric plug of the power cable of the electric outlet strip. To eliminate this problem, electric outlet strips with manual switch means for controlling on/off of each female receptacle thereof are created. However, this design of electric outlet strip is still not satisfactory in function due to the following disadvantages:
1. An electric outlet strip has multiple female receptacles for the connection of a number of electronic/electric devices. When the connected electronic/electric devices are switched off, they still consume a certain amount of electric energy during their standby mode. At this time, these electronic/electric devices keep discharging carbon dioxide to worsen the global greenhouse effect.
2. An electric outlet strip may be equipped with multiple on/off switches for enabling the user to switch on/off each female receptacle manually. However, the user may forget to switch off these on/off switches after turn off the connected electronic/electric devices, causing a waste of electric energy.
3. If multiple electronic devices of a system (for example, host computer and peripheral apparatuses of a computer system) are connected to one electric outlet strip and the host of the system is turned off, the peripheral apparatuses of the system will keep consuming electricity, causing a waste of electric energy.

Therefore, it is desirable to provide an electric outlet strip, which eliminates the aforesaid problems and avoids a waste of electric energy.

### SUMMARY OF THE INVENTION

The present invention has been accomplished under the circumstances in view. It is one object of the present invention to provide an electric outlet power control device, which automatically cuts off power supply from all the female receptacles when the host of the system being connected to female receptacles of the electric outlet strip is off, saving power consumption.

To achieve this and other objects of the present invention, an electric outlet power control device comprises an electric outlet strip having female receptacles for providing power supply to the host (for example, host computer) and peripheral apparatuses (for example, printer, scanner, speaker system, and/off LCD monitor) of an electronic system (for example, computer system), and a control module, which is installed in the electric outlet strip, comprising a sensor for sensing the current signal of the host of the electronic system and an electric switch member controllable by the sensor to cut off power supply from all the female receptacles of the electric outlet strip when the host of the electronic system is off.

The control module further comprises a manual button extending out of the electric outlet strip for operation manually by a person to switch on/off the electric switch member.

Further, a counter can be built in the control module and set to count a predetermined on/off operation time of the electric switch member. The user must boot the host within the set time period, otherwise the sensor will drive the electric switch member to switch off the female receptacles.

### BRIEF DESCRIPTION OF THE DRAWINGS

FIG. 1 is a perspective view of an electric outlet power control device in accordance with a first embodiment of the present invention.

FIG. 2 is a circuit block diagram of the electric outlet power control device in accordance with the first embodiment of the present invention.

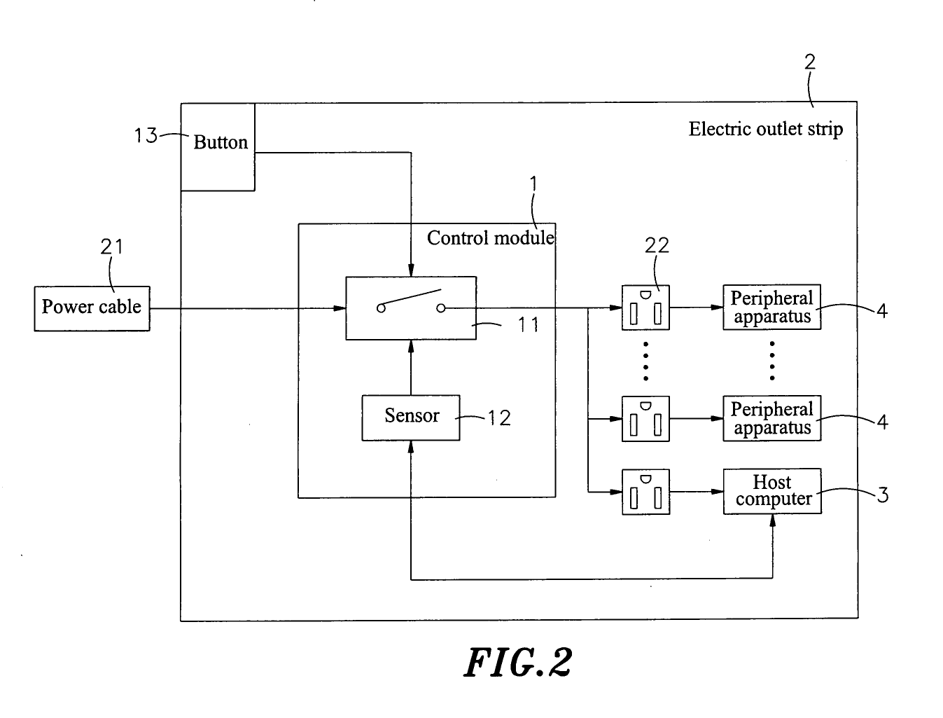

FIG. 3 is a schematic drawing illustrating an application example of the electric outlet power control device in accordance with the first embodiment the first embodiment of the present invention.

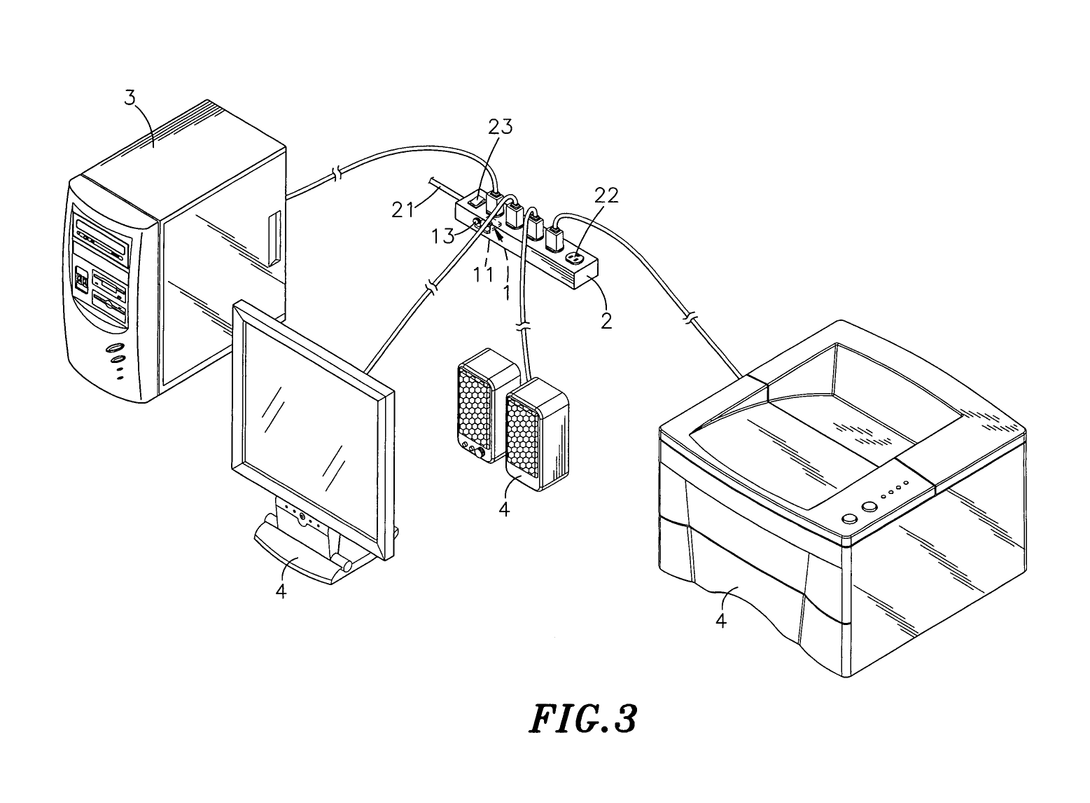

FIG. 4 is a circuit diagram of the electric outlet power control device in accordance with the first embodiment of the present invention.

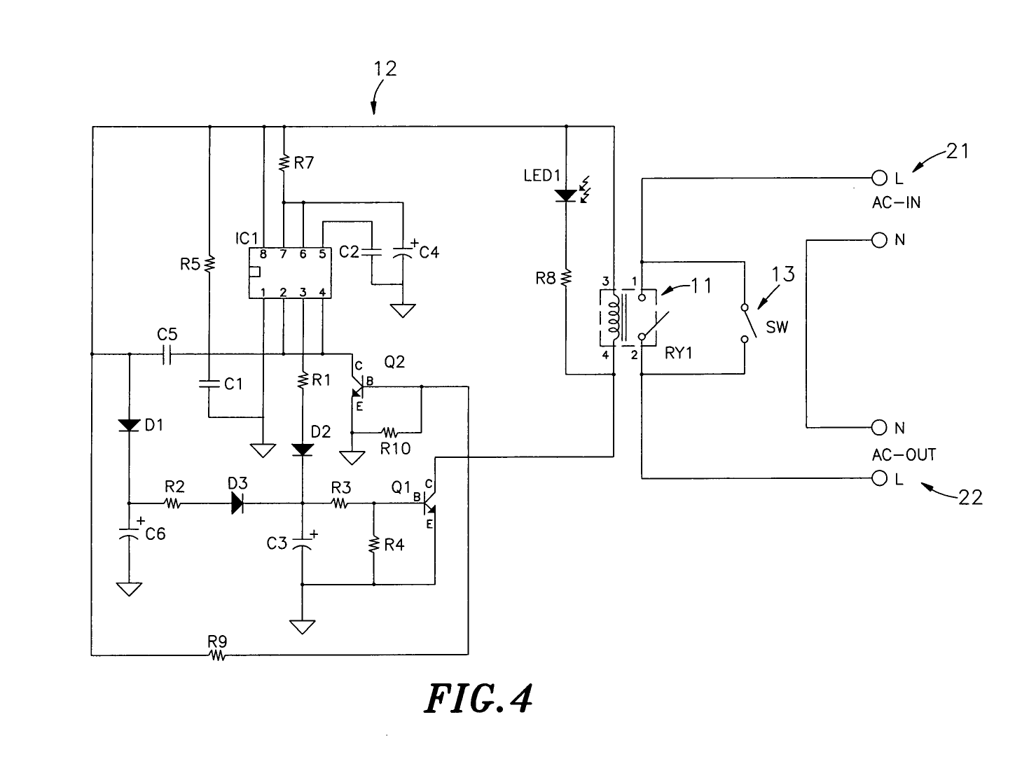

FIG. 5 is a schematic applied view of an electric outlet power control device in accordance with a second embodiment of the present invention.

### DETAILED DESCRIPTION OF THE PREFERRED EMBODIMENT

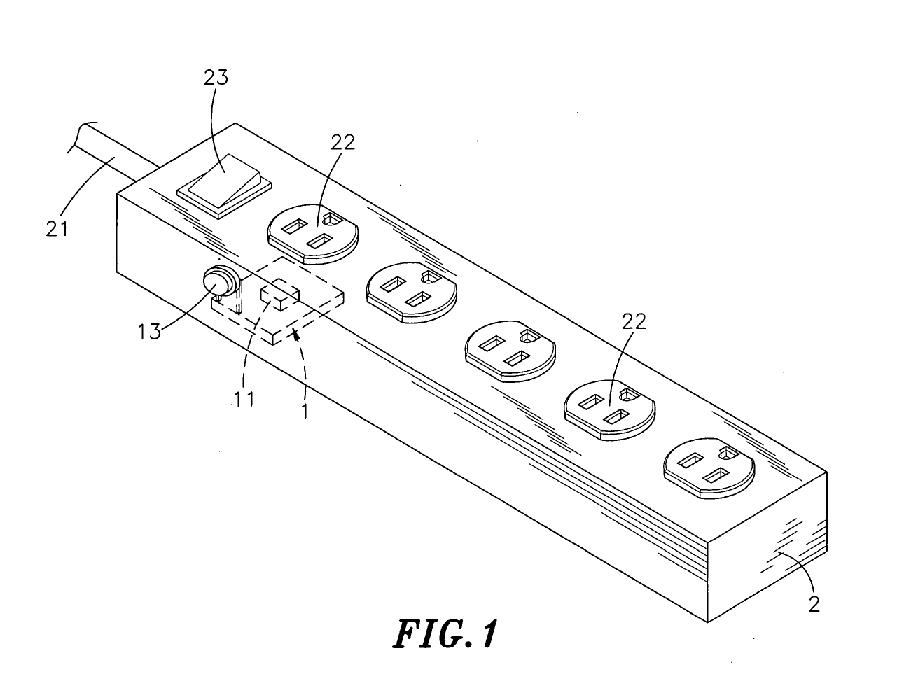

Referring to FIGS. 1˜4, an electric outlet power control device in accordance with a first embodiment of the present invention is shown comprising a control module 1 and an electric outlet strip 2.

The control module 1 is installed in the electric outlet strip 2, comprising an electric switch member 11, a sensor 12, and a manual button 13.

The electric outlet strip 2 comprises a power cable 21 electrically connectable to an external power source (AC power supply, city power supply, power generator, storage battery), a plurality female receptacles 22 electrically connected in series to the power cable 21 for the connection of a host computer 3 and different peripheral apparatuses 4 (such as: printer, scanner, speakers, LCD monitor) and for outputting power supply to the connected host computer 3 and the peripheral apparatuses 4, and an on/off switch 23 for switching on/off the connection between the power cable 21 and the female receptacles 22.

The electric switch member 11 is electrically coupled between the power cable 21 and the female receptacles 22 and switchable to turn on/off the connection between the power cable 21 and the female receptacles 22. The sensor 12 is electrically coupled to the electric switch member 11 and the female receptacles 22, and adapted for sensing on/off current signal of the host computer 3 and switching on/off the electric switch member 11 subject to its detection result. The manual button 13 extends to the outside of the electric outlet strip 2, and adapted for switching on/off the electric switch member 11 manually. Thus, the user can operate the on/off switch 23 to switch on/off the female receptacles and the connected host computer 3 and the peripheral apparatuses 4. When the electric switch member 11 is electrically conducted and the on/off switch 23 is switched on, power supply from the power cable 21 is conducted to the host computer 3 and the peripheral apparatuses 4, enabling the user to boot the host computer 3. When the user switches off the power switch of the host computer 3, the sensor 12 of the control module 1 senses a shutdown current signal, enabling the control module 1 to determine whether or not to drive the electric switch member 11 in switching on or off the circuit. When the electric switch member 11 is switched off, the power cable 21 is prohibited from transmitting power supply to the female receptacles 22, and therefore the connected host computer 3 and the peripheral apparatuses 4 are off, avoiding a waste of electric energy.

Further, when wishing to re-boot the host computer 3 and the related peripheral apparatuses 4, the user can press the manual button 13 to switch on the electric switch member 11, enabling power supply to be conducted to the female receptacles 22. At this time, the user can re-boot the host computer 3 and the related peripheral apparatuses 4. A counter (not shown) can be built in the control module 1 and set to count a predetermined on/off operation time of the electric switch member 11 (for example, 30 seconds, 45 seconds, 60 seconds, or 90 seconds). The user must boot the host computer 3 within the set time period. At this time, the sensor 12 detects the current signal of the host computer 3, and will drive the electric switch member 11 to switch off the circuit between the power cable 21 and the female receptacles 22 if the host computer 3 is not started up within the set time period. Thus, if the host computer 3 and the related peripheral apparatuses 4 are not started up within the set time period, the power supply will be turned off, avoiding a waste of electric energy. This operation manner does some help on stopping global warming.

Further, when the user presses the manual button 13 to switch on the electric switch member 11 manually and the power switch of the host computer 3 is switched on within the set time period after the electric switch member 11 is switched on, power supply is conducted from the power cable 21 to the female receptacles 22 via the electric switch member 11, enabling the host computer 3 and the related peripheral apparatuses 4 to start working. At this time, the sensor 12 keeps sensing the current signal of the host computer 3.

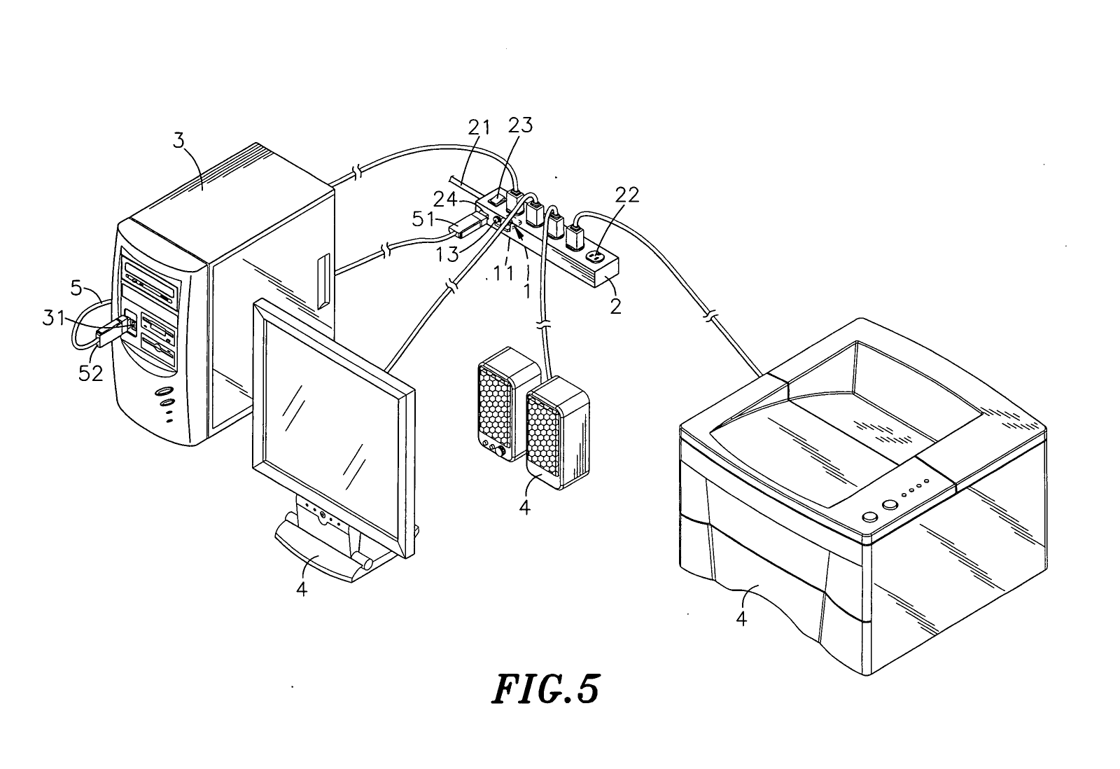

FIG. 5 illustrates an application status of an electric outlet power control device in accordance with a second embodiment of the present invention. This second embodiment is substantially similar to the aforesaid first embodiment with the exception that the electric outlet strip 2 of this second embodiment further comprises an electric port 24 electrically coupled with the power cable 21 and the sensor 12 and electrically connectable to a mating electric port 31 of the host computer 3 by an electric cable 5 that comprises a first electric connector 51 and a second electric connector 52 respectively located on the two distal ends thereof and respectively electrically connectable to the electric port 24 and the mating electric port 31. The electric port 24, the mating electric port 31, the first electric connector 51 and the second electric connector 52 can be configured subject to USB, SATA, ESATA or IEEE interface specifications. Thus, the sensor 12 can detect the On/Off status of the host computer 3 through the electric cable 5, and controls the operation of the electric switch member 11 subject to its detection result.

Further, in either of the aforesaid two different embodiments of the present invention, the electric switch member 11 can be an electromagnetic switch or relay that conducts an electric current to excite a coil for controlling circuit on/off status.

The main technical feature of the present invention is the use of the sensor 12 of the control module 1 to detect the current signal of the host computer 3, enabling the electric switch member 11 to be controlled by the sensor 12 to switch off electric conduction between the power cable 21 and the female receptacles 22 automatically when the host computer 3 is switched off by the user, and therefore power supply is cut off from the host computer 3 and the related peripheral apparatuses (printer, scanner, speakers and/of LCD monitor) 4 automatically when the user switches off the host computer 3.

In conclusion, the invention provides an electric outlet power control device, which has the advantages and features as follows:
1. The electric switch member 11 of the control module 1 can automatically switch on/off the circuit between the power cable 21 and the female receptacles 22. Further, the sensor 12 detects the current signal of the host computer 3, and drives the electric switch member 11 to cut off electric conduction between the power cable 21 and the female receptacles 22 automatically when the host computer 3 is switched off by the user, and therefore the host computer 3 and the related peripheral apparatuses (printer, scanner, speakers and/of LCD monitor) 4 are synchronously turned off when the user switches off the host computer 3.
2. When the host computer 3 that is electrically connected to the first female receptacle 22 of the electric outlet strip 2 is off, the sensor 12 of the control module 1 senses the current signal of the host computer 3 and drives the electric switch member 11 of the control module 1 to switch off the circuit between the power cable 21 and the female receptacles 22, and therefore the host computer 3 and the related peripheral apparatuses 4 are off, avoiding a waste of electric energy and doing some help on stopping global warming.
3. The manual button 13 of the control module 1 extends out of the electric outlet strip 2 for operation by the user to switch on the electric switch member 11 manually, enabling electricity to be transmitted from the power cable 21 to the female receptacles 22 and the loaded host computer 3 and peripheral apparatuses 4.
4. The control module 1 has a counter built therein for counting a predetermined time period after the electric switch member 11 is switched on, and driving the sensor 12 to detect the current signal of the host computer 3 after counting, and therefore the sensor 12 will drive the electric switch member 11 to cut off power supply from the female receptacles 22 and the loaded host computer 3 and peripheral apparatuses 4 if the user does not start up the host computer 3 within the set time.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An electric outlet power control device, comprising:
an electric outlet strip , said electric outlet strip comprising a main female receptacle for providing electricity to a host computer and at least one supplementary female receptacle for providing electricity to at least one computer peripheral apparatus, a power cable electrically connected with said main female receptacle and said at least one supplementary female receptacle and adapted for connection to an AC power source to conduct electricity to said main female receptacle and said at least one supplementary female receptacle, and an on/off switch operable to switch on/off electric conduction between said power cable and said main female receptacle and said at least one supplementary female receptacle; and
a control module installed in said electric outlet strip, said control module comprising an electric switch member controllable to switch on/off electric conduction between said on/off switch and said main female receptacle and at least one supplementary female receptacle, and a sensor electrically coupled with said electric switch member and adapted for sensing a current signal of the host computer being connected to said main female receptacle and driving said electric switch member to switch off electric conduction said on/off switch and said main female receptacle and at least one supplementary female receptacle when said host computer is off.

2. The electric outlet power control device as claimed in claim 1, wherein said control module further comprises a manual button extending out of said electric outlet strip for operation manually by a person to switch on/off said electric switch member.

3. The electric outlet power control device as claimed in claim 1, wherein said electric switch member of said control module is an electromagnetic switch.

4. The electric outlet power control device as claimed in claim 1, wherein said electric switch member of said control module is a relay.

5. The electric outlet power control device as claimed in claim 1, wherein said electric outlet strip further comprises an electric port electrically coupled with said power cable and said sensor and electrically connectable to a mating electric port of an external host computer by an electric cable that comprises a first electric connector and a second electric connector respectively located on two distal ends thereof and respectively electrically connectable to said electric port and the mating electric port of said external host computer .

6. The electric outlet power control device as claimed in claim 5, wherein said electric port is configured subject to one of USB and IEEE interface specifications.
